(19) United States
(12) Patent Application Publication
(10) Pub. No.: US 2020/0372409 A1
(43) Pub. Date: Nov. 26, 2020

(54) ELECTROMAGNETIC DISTORTION COMPENSATION FOR DEVICE TRACKING

(71) Applicant: Boston Scientific Scimed Inc., Maple Grove, MN (US)

(72) Inventors: Kyle H. Srivastava, St Paul, MN (US); Anton Plotkin, Plymouth, MN (US); Daniel J. Foster, Lino Lakes, MN (US); Richard J. Spartz, Blaine, MN (US); Hamid Mokhtarzadeh, Maple Grove, MN (US)

(21) Appl. No.: 16/879,880

(22) Filed: May 21, 2020

Related U.S. Application Data
(60) Provisional application No. 62/852,784, filed on May 24, 2019.

(51) Int. Cl. G06N 20/00; G01D 18/00; G01D 5/00

(52) U.S. Cl. CPC G06N 20/00; G01D 5/00; G01D 18/00

(57) ABSTRACT

A system and method for compensating for electromagnetic (EM) distortion fields caused by one or more distortion objects is provided. A system and method for compensating for electromagnetic (EM) distortion fields caused by one or more distortion objects is provided. For example, an EM compensation device receives a plurality of EM field calibration measurements. The EM compensation device trains a machine learning dataset to compensate for the EM distortion fields from the one or more distortion objects using the plurality of EM field calibration measurements and/or an EM field model. The EM compensation device receives one or more EM field procedure measurements from a medical device performing a medical procedure. The EM compensation device predicts a spatial location of the medical device based on the EM field procedure measurement and the machine learning dataset.

### CROSS REFERENCE TO RELATED APPLICATION

This application claims priority to Provisional Application No. 62/852,784, filed May 24, 2019, which is herein incorporated by reference in its entirety.

### TECHNICAL FIELD

The present disclosure relates to systems, methods, and devices for tracking medical devices. More specifically, the disclosure relates to systems, methods, and devices for electro-magnetically tracking medical devices used in medical procedures.

### BACKGROUND

A variety of systems, methods, and devices may be used to track medical devices. Tracking systems may use a magnetic field generator to generate magnetic fields that are sensed by at least one tracking sensor in the tracked medical device. The generated magnetic fields provide a fixed frame of reference, and the tracking sensor senses the magnetic fields to determine the location and orientation of the sensor in relation to the fixed frame of reference.

However, due to electromagnetic field distortions caused by distortion (e.g., metallic, paramagnetic or ferromagnetic objects, systems, and/or devices), the tracking system may have difficulty tracking and/or incorrectly track the position of the medical device. These distortions may be caused by eddy currents that are induced in the distortion objects by magnetic field generators, as well as by other effects. Accordingly, there exists a need for one or more improved methods and/or systems in order to address one or more of the above-noted drawbacks.

### SUMMARY

In Example 1, a system for compensating for electromagnetic (EM) distortion fields caused by one or more distortion objects is provided. The system comprises a calibration device configured to provide a plurality of EM field calibration measurements. The system also comprises an EM compensation device including one or more processors and memory storing instructions that, when executed by the one or more processors, cause the one or more processors to receive, from the calibration device, the plurality of EM field calibration measurements within a defined area, receive, from a tracker device, a plurality of determined spatial locations of the calibration device, wherein each of the plurality of determined spatial locations corresponds to a corresponding EM field calibration measurement from the plurality of EM field calibration measurements, receive one or more EM field procedure measurements from a medical device performing a medical procedure, and predict a spatial location of the medical device based on the one or more EM field procedure measurements, the plurality of determined spatial locations of the calibration device, and the plurality of EM field calibration measurement.

In Example 2, the system of Example 1, wherein the calibration device comprises one or more magnetic field generators.

In Example 3, the system of any of Examples 1 or 2, wherein the memory storing instructions that, when executed by the one or more processors, further cause the one or more processors to train a machine learning dataset to compensate for the EM distortion fields caused by the one or more distortion objects using the plurality of EM field calibration measurements and an EM field model, and wherein the predicting the spatial location of the medical device is further based on the machine learning dataset.

In Example 4, the system of Example 3, wherein the training the machine learning dataset comprises using the plurality of EM field calibration measurements, the EM field model, and the machine learning dataset to determine a predicted spatial location of the calibration device and updating the machine learning dataset based on an error between the predicted spatial location and a determined spatial location from the plurality of determined spatial locations.

In Example 5, the system of any of Examples 1-4, wherein the memory storing instructions that, when executed by the one or more processors, further cause the one or more processors to determine, based on one or more magnetic field generators, the EM field model, wherein the EM field model indicates a plurality of non-distorted EM field measurements within the defined area that are caused solely by the one or more magnetic field generators.

In Example 6, the system of any of Examples 1-5, wherein the calibration device comprises a plurality of magnetic field detection sensors, and wherein each of the plurality of EM field calibration measurements indicates a corresponding magnetic field detection sensor, from the plurality of magnetic field detection sensors, that determined the EM field calibration measurement.

In Example 7, the system of Example 6, wherein the memory storing instructions that, when executed by the one or more processors, further cause the one or more processors to determine geometric spacing for the calibration device and corresponding to the plurality of magnetic field detection sensors, and wherein the training the machine learning dataset is further based on the geometric spacing corresponding to the plurality of magnetic field detection sensors.

In Example 8, the system of any of Examples 1-7, wherein the training the machine learning dataset comprises determining a first error corresponding to a predicted spatial location of the calibration device and a determined spatial location from the tracker device, wherein the predicted spatial location is determined using the machine learning dataset, and updating the machine learning dataset based on the first error.

In Example 9, the system of Example 8, wherein the training the machine learning dataset comprises determining a second error corresponding to a determined geometric spacing between a plurality of magnetic field detection sensors corresponding to the calibration device and an actual geometric spacing between the plurality of magnetic field detection sensors, wherein the determined geometric spacing is determined using the machine learning dataset, and updating the machine learning dataset based on the second error.

In Example 10, the system of Example 9, wherein the updating the machine learning dataset comprises prioritizing the second error corresponding to the determined geometric spacing and the actual geometric spacing over the first error corresponding to the predicted spatial location and the determined spatial location.

In Example 11, the system of any of Examples 1-10, wherein the memory storing instructions that, when executed by the one or more processors, further cause the one or more processors to receive, from the calibration device, a plurality of determined orientation measurements of the calibration device, wherein each of the plurality of determined orientation measurements corresponds to a corresponding EM field calibration measurement from the plurality of EM field calibration measurements, train the machine learning dataset based on the plurality of determined orientation measurements, and predict an orientation of the medical device based on the machine learning dataset and the one or more EM field procedure measurements.

In Example 12, the system of any of Examples 1-11, wherein the tracker device includes an optical tracker device.

In Example 13, the system of any of Examples 1-12, wherein the tracker device includes an inertial measurement unit (IMU).

In Example 14, the system of any of Examples 1-13, wherein the tracker device includes a depth camera.

In Example 15, the system of any of Examples 1-14, wherein the tracker device includes a laser tracker.

In Example 16, a method for compensating for electromagnetic (EM) distortion fields caused by one or more distortion objects comprises receiving, by an EM compensation device and from a calibration device, a plurality of EM field calibration measurements within a defined area, training, by the EM compensation device, a machine learning dataset to compensate for the EM distortion fields caused by the one or more distortion objects using the plurality of EM field calibration measurements and an EM field model, receiving, by the EM compensation device, one or more EM field procedure measurements from a medical device performing a medical procedure, and predicting a spatial location of the medical device based on the one or more EM field procedure measurements and the machine learning dataset.

In Example 17, the method of Example 16, further comprising receiving, by the EM compensation device and from a tracker device, a plurality of determined spatial locations of the calibration device, wherein each of the plurality of determined spatial locations corresponds to a corresponding EM field calibration measurement from the plurality of EM field calibration measurements, and wherein the training the machine learning dataset is further based on the plurality of determined spatial locations of the calibration device.

In Example 18, the method of Example 17, wherein the training the machine learning dataset comprises using the plurality of EM field calibration measurements, the EM field model, and the machine learning dataset to determine a predicted spatial location of the calibration device, and updating the machine learning dataset based on an error between the predicted spatial location and a determined spatial location from the plurality of determined spatial locations.

In Example 19, the method of Example 17, wherein the tracker device includes at least one of: an optical tracker device, an inertial measurement unit (IMU), a depth camera, and a laser tracker.

In Example 20, the method of Example 16, further comprising determining, based on one or more magnetic field generators, the EM field model, wherein the EM field model indicates a plurality of non-distorted EM field measurements within the defined area that are caused solely by the one or more magnetic field generators.

In Example 21, the method of Example 16, wherein the calibration device comprises a plurality of magnetic field detection sensors, and wherein each of the plurality of EM field calibration measurements indicates a corresponding magnetic field detection sensor, from the plurality of magnetic field detection sensors, that determined the EM field calibration measurement.

In Example 22, the method of Example 21, further comprising determining geometric spacing for the calibration device and corresponding to the plurality of magnetic field detection sensors, and wherein the training the machine learning dataset is further based on the geometric spacing corresponding to the plurality of magnetic field detection sensors.

In Example 23, the method of Example 16, wherein the training the machine learning dataset comprises determining a first error corresponding to a predicted spatial location of the calibration device and a determined spatial location from a tracker device, wherein the predicted spatial location is determined using the machine learning dataset, determining a second error corresponding to a determined geometric spacing between a plurality of magnetic field detection sensors corresponding to the calibration device and an actual geometric spacing between the plurality of magnetic field detection sensors, wherein the determined geometric spacing is determined using the machine learning dataset, and updating the machine learning dataset based on the first error and the second error.

In Example 24, the method of Example 23, wherein the updating the machine learning dataset comprises prioritizing the second error corresponding to the determined geometric spacing and the actual geometric spacing over the first error corresponding to the predicted spatial location and the determined spatial location.

In Example 25, the method of Example 16, further comprising receiving, from the calibration device, a plurality of determined orientation measurements of the calibration device, wherein each of the plurality of determined orientation measurements corresponds to a corresponding EM field calibration measurement from the plurality of EM field calibration measurements, training the machine learning dataset based on the plurality of determined orientation measurements, and predicting an orientation of the medical device based on the machine learning dataset and the one or more EM field procedure measurements.

In Example 26, a system for compensating for electromagnetic (EM) distortion fields caused by one or more distortion objects. The system comprises a calibration device configured to provide a plurality of EM field calibration measurements. The system also comprises an EM compensation device including one or more processors and memory storing instructions that, when executed by the one or more processors, cause the one or more processors to receive, from the calibration device, the plurality of EM field calibration measurements within a defined area, receive, from a tracker device, a plurality of determined spatial locations of the calibration device, wherein each of the plurality of determined spatial locations corresponds to a corresponding EM field calibration measurement from the plurality of EM field calibration measurements, receive one or more EM field procedure measurements from a medical device performing a medical procedure, and predict a spatial location of the medical device based on the one or more EM field procedure measurements, the plurality of determined spatial locations of the calibration device, and the plurality of EM field calibration measurement.

In Example 27, the system of Example 26, wherein the calibration device comprises one or more magnetic field generators.

In Example 28, the system of Example 26, wherein the memory storing instructions that, when executed by the one or more processors, further cause the one or more processors to train a machine learning dataset to compensate for the EM distortion fields caused by the one or more distortion objects using the plurality of EM field calibration measurements and an EM field model, and wherein the predicting the spatial location of the medical device is further based on the machine learning dataset.

In Example 29, the system of Example 28, wherein the training the machine learning dataset comprises using the plurality of EM field calibration measurements, the EM field model, and the machine learning dataset to determine a predicted spatial location of the calibration device, and updating the machine learning dataset based on an error between the predicted spatial location and a determined spatial location from the plurality of determined spatial locations.

In Example 30, the system of Example 28, wherein the calibration device comprises a plurality of magnetic field detection sensors, and wherein each of the plurality of EM field calibration measurements indicates a corresponding magnetic field detection sensor, from the plurality of magnetic field detection sensors, that determined the EM field calibration measurement.

In Example 31, the system of Example 30, wherein the memory storing instructions that, when executed by the one or more processors, further cause the one or more processors to determine geometric spacing for the calibration device and corresponding to the plurality of magnetic field detection sensors, and wherein the training the machine learning dataset is further based on the geometric spacing corresponding to the plurality of magnetic field detection sensors.

In Example 32, the system of Example 28, wherein the training the machine learning dataset comprises determining a first error corresponding to a predicted spatial location of the calibration device and a determined spatial location from the tracker device, wherein the predicted spatial location is determined using the machine learning dataset, determining a second error corresponding to a determined geometric spacing between a plurality of magnetic field detection sensors corresponding to the calibration device and an actual geometric spacing between the plurality of magnetic field detection sensors, wherein the determined geometric spacing is determined using the machine learning dataset, and updating the machine learning dataset based on the first error and the second error.

In Example 33, the system of Example 28, wherein the memory storing instructions that, when executed by the one or more processors, further cause the one or more processors to receive, from the calibration device, a plurality of determined orientation measurements of the calibration device, wherein each of the plurality of determined orientation measurements corresponds to a corresponding EM field calibration measurement from the plurality of EM field calibration measurements, train the machine learning dataset based on the plurality of determined orientation measurements, and predict an orientation of the medical device based on the machine learning dataset and the one or more EM field procedure measurements.

In Example 34, a non-transitory computer readable medium storing instructions for execution by one or more processors incorporated into a system, wherein execution of the instructions by the one or more processors cause the one or more processors to receive, from a calibration device, a plurality of EM field calibration measurements within a defined area, receive, from a tracker device, a plurality of determined spatial locations of the calibration device, wherein each of the plurality of determined spatial locations corresponds to a corresponding EM field calibration measurement from the plurality of EM field calibration measurements, receive one or more EM field procedure measurements from a medical device performing a medical procedure, and predict a spatial location of the medical device based on the one or more EM field procedure measurements, the plurality of determined spatial locations of the calibration device, and the plurality of EM field calibration measurements.

In Example 35, the non-transitory computer readable medium of Example 34, wherein execution of the instructions by the one or more processors further cause the one or more processors to train a machine learning dataset to compensate for the EM distortion fields caused by one or more distortion objects using the plurality of EM field calibration measurements and an EM field model, and wherein the predicting the spatial location of the medical device is further based on the machine learning dataset.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a schematic of an electromagnetic (EM) field compensation system, in accordance with certain embodiments of the present disclosure.

FIG. 2 shows a block representation of an EM compensation device, in accordance with certain embodiments of the present disclosure.

FIG. 3A shows a perspective view of a calibration device, in accordance with certain embodiments of the present disclosure.

FIG. 3B shows a perspective view of another calibration device, in accordance with certain embodiments of the present disclosure.

FIGS. 4A and 4B depict an exemplary clinical setting including an electrophysiology mapping and navigation system incorporating the EM field compensation system, in accordance with certain embodiments of the present disclosure.

FIG. 5 shows a block representation of steps in a method for compensating for EM distortion fields from one or more distortion objects, in accordance with certain embodiments of the present disclosure.

FIG. 6 shows another block representation of steps in a method for compensating for EM distortion fields from one or more distortion objects, in accordance with certain embodiments of the present disclosure.

FIG. 7 represents features of a neural network, in accordance with certain embodiments of the present disclosure.

FIG. 8 shows a diagram of features of a neural network, in accordance with certain embodiments of the present disclosure.

FIG. 9 shows a graphical representation of using a neural network to compensate for EM distortion fields, in accordance with certain embodiments of the present disclosure.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

During medical procedures, medical devices such as probes (e.g., catheters, imaging probes, diagnostic probes) may be inserted into a patient. To track the location and orientation of a probe within the patient, probes may be provisioned with magnetic field sensors that detect various magnetic fields generated by one or more magnetic field generators near the patient. The amplitude and/or phase of the detected magnetic fields may be used to determine location and/or orientation of the probe. Tracking errors may be caused by one or more distortion objects (e.g., metallic, paramagnetic or ferromagnetic objects and/or devices). As such, certain embodiments of the present disclosure are accordingly directed to systems, methods, and/or devices that use one or more machine learning algorithms to compensate for EM distortion fields caused by the distortion objects such that the medical device may be more accurately tracked during the medical procedure (e.g., a particular medical treatment or prophylaxis for a disease or medical condition).

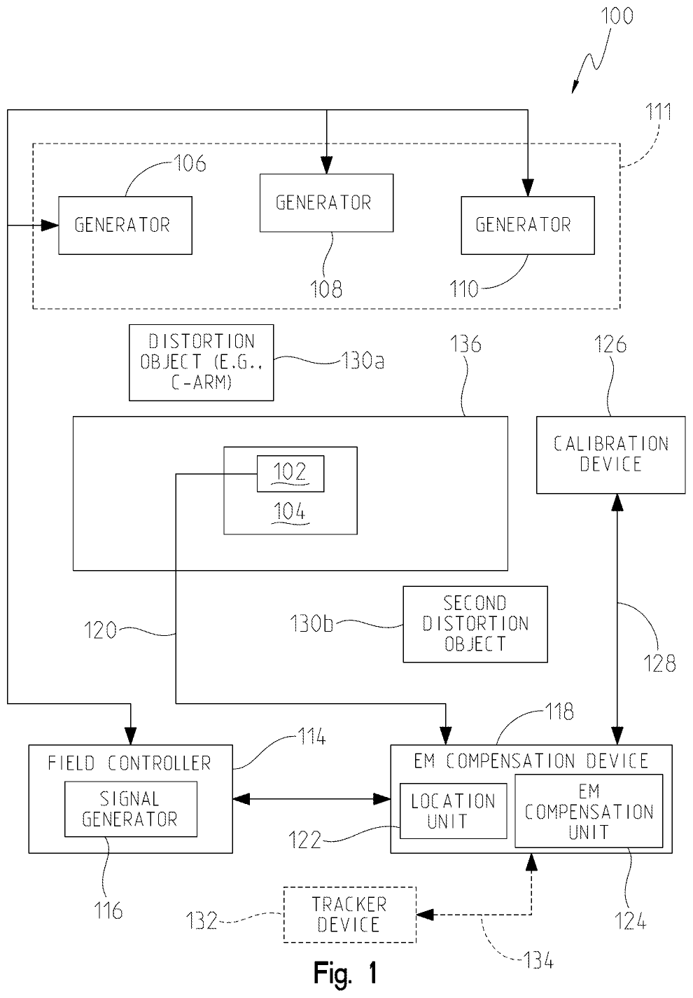

FIG. 1 is a schematic block diagram depicting an exemplary electromagnetic (EM) field compensation system 100 that is configured to compensate for the EM distortion fields caused by one or more distortion objects. For example, one or more magnetic field generator assemblies 106, 108, and 110 may induce one or more distortion objects (e.g., distortion objects 130a and/or b) to produce EM distortion fields. The system 100 may calibrate for the EM distortion fields from these distortion objects (e.g., distortion objects 130a and/or b). After calibrating for the EM distortion fields and during a medical procedure, the system 100 may determine location information for a medical device 104 based on information collected using a receiver (e.g., sensor) 102 operatively coupled to a medical device 104 (e.g., probe). The information collected by the receiver 102 may include a received field signal indicating the EM distortion field transmitted by the distortion objects 130a and/or 130b and/or an EM generator field defined by a set of electromagnetic signals transmitted by the one or more magnetic field generator assemblies 106, 108, and 110. Although only three magnetic field generator assemblies are shown, the system 100 can include fewer or more magnetic field generator assemblies. Furthermore, although only two distortion objects are shown, the system 100 may include fewer or more distortion objects 130a and/or 130b.

In some examples, to provide six-degree-of-freedom tracking, the EM field compensation system 100 may include at least one magnetic field generator assembly when the receiver 102 includes a three-axis sensor (e.g., three-axis magnetic sensor). Additional magnetic field generator assemblies may be used to extend the range and accuracy of tracking. When the receiver 102 includes a dual-axis sensor (e.g., dual-axis magnetic sensor), the EM field compensation system 100 may include at least two magnetic field generator assemblies. In embodiments with multiple magnetic field generator assemblies, one or more magnetic field generator assemblies 106, 108, and/or 108 may be coupled to a common housing or placed individually. When coupled together, the magnetic field generator assemblies 106, 108, and/or 110, the housing, and other components forms a magnetic field transmitter assembly (e.g., magnetic field transmitter assembly 111). The magnetic field transmitter assembly 111 may be placed under a patient's bed, under the patient but above the patient's bed, and/or placed above the patient (e.g., placed directly on top of the patient or suspended above the patient). In FIG. 1, the magnetic field generator assemblies 106, 108, and 110 are positioned within a magnetic field transmitter assembly 111.

The magnetic field generator assemblies 106, 108, and/or 110 may be coil-based (e.g., includes one or more coil windings), and/or permanent-magnet-based—each of which is discussed in more detail below. The one or more magnetic field generator assemblies 106, 108, and 110 are configured to transmit (e.g., radiate and/or produce) electromagnetic signals, which produce an EM generated field. The EM generated field may induce the distortion objects (e.g., distortion objects 130a and 130b) to transmit additional electromagnetic signals, which produce an EM distortion field. The distortion objects may be any object that produces an EM distortion field when induced by the EM generated field. Exemplarily distortion objects include, but are not limited to, metallic objects, paramagnetic objects, ferromagnetic objects, systems, computing devices, and/or medical devices. For example, the distortion object 130a may be a radiological imaging device (e.g., an angiography/fluoroscopy imaging device) such as a C-arm. The C-arm 130a may be physically positioned in one or more orientations. Each of the orientations of the C-arm 130a may cause a different EM distortion field. The system 100 may compensate for each of these orientations, which will be described in further detail below.

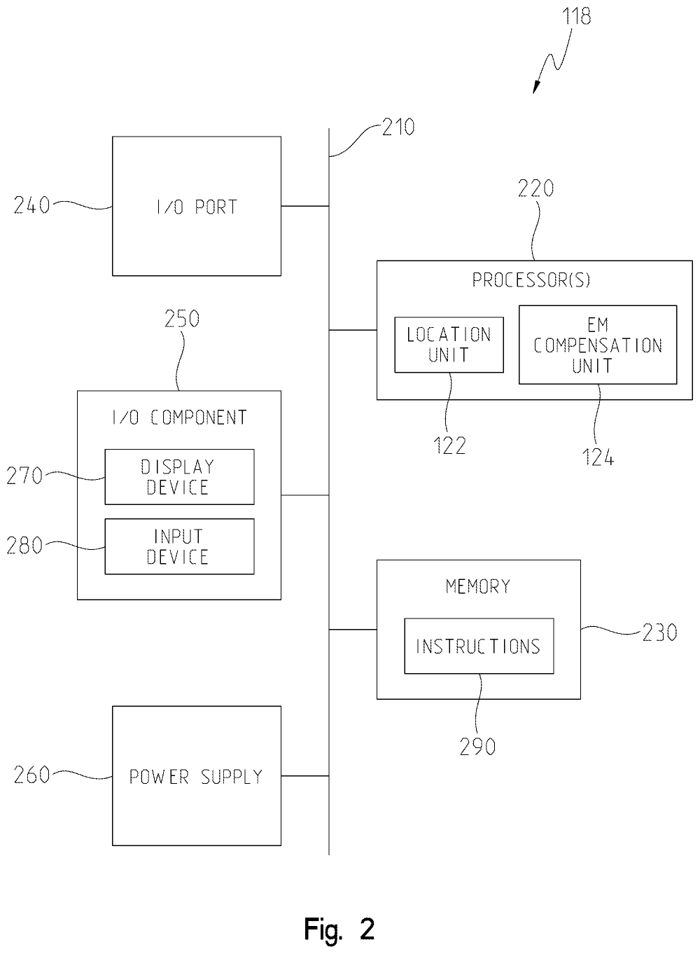

The system 100 also includes a magnetic field controller 114 configured to manage operation of the magnetic field generator assemblies 106, 108, and 110. As shown in FIG. 1, the magnetic field controller 114 includes a signal generator 116 configured to provide driving current to each of the magnetic field generator assemblies 106, 108, and 110, causing each magnetic field generator assembly to transmit one or more electromagnetic signals (e.g., EM generated fields). In certain embodiments, the signal generator 116 is configured to provide sinusoidal driving currents to the magnetic field generator assemblies 106, 108, and 110. The magnetic field controller 114 may be implemented using firmware, integrated circuits, and/or software modules that interact with each other or are combined together. For example, the magnetic field controller 114 may include computer-readable instructions/code for execution by one or more processors (see FIG. 2). Such instructions may be stored on a non-transitory computer-readable medium (see FIG. 2) and transferred to the processor for execution. In some instances, the magnetic field controller 114 may be implemented in one or more application-specific integrated circuits and/or other forms of circuitry suitable for controlling and processing magnetic tracking signals and information.

The receiver 102 (e.g., magnetic field sensor) (which may include one or more receivers/sensors) may be configured to produce an electrical response to sensed (e.g., detected) the magnetic field(s). For example, the receiver 102 may include a magnetic field sensor such as inductive sensing coils and/or various sensing elements such as magneto-resistive (MR) sensing elements (e.g., anisotropic magneto-resistive (AMR) sensing elements, giant magneto-resistive (GMR) sensing elements, tunneling magneto-resistive (TMR) sensing elements, Hall effect sensing elements, colossal magneto-resistive (CMR) sensing elements, extraordinary magneto-resistive (EMR) sensing elements, spin Hall sensing elements, and the like), giant magneto-impedance (GMI) sensing elements, and/or flux-gate sensing elements.

The medical device 104 communicates (e.g., transmits and/or provides) the sensed magnetic field signal to an EM compensation device 118, which is configured to analyze the sensed magnetic field signal to determine location information corresponding to the receiver 102 (and, thus, the medical device 104). Location information may include any type of information associated with a spatial location of a medical device 104 such as, for example, location, relative location (e.g., location relative to another device and/or location), position, orientation, velocity, acceleration, and/or the like. As mentioned above, the EM field compensation system 100 may utilize amplitude and/or phase (e.g., differences in phase) of the sensed magnetic field signal to determine the spatial location and/or the orientation of the medical device 104.

In some variations, the EM field compensation system 100 may include one or more reference sensors that are configured and arranged to sense the magnetic fields generated by the magnetic field generator assemblies 106-110. The sensor may be a magnetic sensor (e.g., dual-axis magnetic sensor, tri-axis magnetic sensor) and be positioned at a known reference point in proximity to the magnetic field generator assemblies, 106-110, to act as a reference sensor. For example, one or more sensors can be coupled to the subject's bed, an arm of an x-ray machine, or at other points a known distance from the magnetic field generator assemblies, 106-110. In some embodiments, the at least one sensor is mounted to one of the magnetic field generator assemblies, 106-110.

The medical device 104 may include, for example, a catheter (e.g., a mapping catheter, an ablation catheter, a diagnostic catheter, an introducer), an endoscopic probe or cannula, an implantable medical device (e.g., a control device, a monitoring device, a pacemaker, an implantable cardioverter defibrillator (ICD), a cardiac resynchronization therapy (CRT) device, a CRT-D), guidewire, endoscope, biopsy needle, ultrasound device, reference patch, robot and/or the like. For example, in embodiments, the medical device 104 may include a mapping catheter associated with an anatomical mapping system. The medical device 104 may include any other type of device configured to be at least temporarily disposed within a subject (e.g., patient). The subject may be a human, a dog, a pig, and/or any other animal having physiological parameters that can be recorded. For example, in embodiments, the subject may be a human patient.

As shown in FIG. 1, the medical device 104 may be configured to be communicatively coupled to the EM compensation device 118 via a communication link 120. In embodiments, the communication link 120 may be, or include, a wired communication link (e.g., a serial communication), a wireless communication link such as, for example, a short-range radio link, such as Bluetooth, IEEE 802.11, a proprietary wireless protocol, and/or the like. The term “communication link” may refer to an ability to communicate some type of information in at least one direction between at least two devices, and should not be understood to be limited to a direct, persistent, or otherwise limited communication channel. That is, in some embodiments, the communication link 120 may be a persistent communication link, an intermittent communication link, an ad-hoc communication link, and/or the like. The communication link 120 may refer to direct communications between the medical device 104 and the EM compensation device 118, and/or indirect communications that travel between the medical device 104 and the EM compensation device 118 via at least one other device (e.g., a repeater, router, hub, and/or the like). The communication link 120 may facilitate uni-directional and/or bi-directional communication between the medical device 104 and the EM compensation device 118. Information, data, and/or control signals may be transmitted between the medical device 104 and the EM compensation device 118 to coordinate the functions of the medical device 104 and/or the EM compensation device 118.

The EM compensation device 118 may also be configured to be communicatively coupled to a calibration device 126. The calibration device 126 may be used to calibrate and/or compensate for the EM distortion fields produced by the distortion objects such as 130a and 130b. The calibration device 126 may include one or more magnetic field detection sensors (e.g., one, four, eight, and/or any number of magnetic field sensors). The magnetic field detection sensors may be configured to operate similar to the receiver 102. For example, the information collected by the calibration device 126 may include a received field signal indicating the EM distortion field transmitted by the distortion objects 130a and/or 130b and/or an EM generator field defined by a set of electromagnetic signals transmitted by the one or more magnetic field generator assemblies 106, 108, and 110. The magnetic field detection sensors may include one or more inductive sensing coils and/or various sensing elements and/or magneto-resistive (MR) sensing elements (e.g., anisotropic magneto-resistive (AMR) sensing elements, giant magneto-resistive (GMR) sensing elements, tunneling magneto-resistive (TMR) sensing elements, Hall effect sensing elements, colossal magneto-resistive (CMR) sensing elements, extraordinary magneto-resistive (EMR) sensing elements, spin Hall sensing elements, and the like), giant magneto-impedance (GMI) sensing elements, and/or flux-gate sensing elements).

The calibration device 126 may be configured to be communicatively coupled to the EM compensation device 118 via a communication link 128. In some examples, the communication link 128 is similar to communication link 120 and may be, or include, a wired communication link (e.g., a serial communication), a wireless communication link such as, for example, a short-range radio link, such as Bluetooth, IEEE 802.11, a proprietary wireless protocol, and/or the like.

The EM compensation device 118 includes a location unit 122 and an EM compensation unit 124. As used herein, the term “unit” refers to, be part of, or include an Application Specific Integrated Circuit (ASIC), an electronic circuit, a processor or microprocessor (shared, dedicated, or group) and/or memory (shared, dedicated, or group) that executes one or more software or firmware programs, a combinational logic circuit, and/or other suitable components that provide the described functionality.

The location unit 122 is configured to determine, based on the sensed field signal (e.g., the phase, amplitude, differences in phase and/or amplitude of the sensed field signal), location information corresponding to the medical device 104 and/or the calibration device 126. The location unit 122 may be configured to determine location information according to any location-determination technique that uses magnetic navigation. The EM compensation unit 124 is configured to compensate for the EM distortion fields caused by the distortion objects such as objects 130a and/or 130b. In some examples, the EM compensation unit 124 may use machine learning algorithms (e.g., artificial neural network algorithms) to compensate for the EM distortion fields.

The system 100 may optionally include one or more tracker devices such as tracker device 132. When present, the tracker device 132 determines location information for the calibration device 126. Location information may include any type of information associated with a spatial location of the calibration device 126 such as, for example, location, relative location (e.g., location relative to another device and/or location), position, orientation, velocity, acceleration, and/or the like. The one or more tracker devices may include and/or be an optical camera/tracker, a depth camera, an inertial measurement unit (IMU), a laser tracker. In some examples, the tracker device 132 may be an IMU that includes one or more devices that measure acceleration (e.g., an accelerometer), velocity/angular velocity (e.g., gyroscopes), and/or magnetic fields (e.g., magnetometers). In some variations, the tracker device 132 is within the calibration device 126. For example, the optical camera/tracker, the depth camera, the IMU, and/or the laser tracker may be within the calibration device 126.

In some instances, the tracker device 132 may be an optical tracker that is positioned and/or operatively coupled to a cart, a console, or fix-mounted within a room (e.g., defined area) that the medical procedure is taking place in. For instance, one or more optical trackers may be on the ceiling of the room. In such examples, the calibration device 126 may include optical targets to assist the tracker device 132 determine the location information. Optical targets may include, but are not limited to, a checkerboard style or other style and/or infrared light-emitting diode (IR LED). In some variations, the tracker device 132 may be within the calibration device 126. In such variations, the optical targets may be on a bed or table 136 that a patient undergoing the medical procedure is situated, attached or operatively coupled to the patient, attached or operatively coupled to the one or more field generator assemblies 106, 108, and/or 110 and/or the magnetic field transmitter assembly 111. In some instances, the optical tracker may be a depth camera located within the calibration device 126. The depth camera may be configured to use a simultaneous localization and mapping (SLAM) algorithm to extract 3-D shapes (e.g., a patient body) and/or to determine a static reference for position registration of the calibration device 126. Types of depth cameras include, but are not limited to, structured light devices, stereo cameras, stereo cameras and IMUs, time of flight (TOF) devices, and/or TOF devices and IMUs.

In some variations, the tracker device 132 is a laser tracker. The laser tracker may be positioned within the room and may be operatively coupled to a console or device within the room. In such variations, the tracker device 132 includes a prism and/or reflector to assist the tracker device 132 determine the location information.

In some instances, the system 100 may be a reciprocal system. In other words, the calibration device 126, the medical device 104, and/or one or more additional devices may include one or more magnetic field generator assemblies 106-110 that generate EM fields (AC/DC EM fields). Another device, such as the magnetic field transmitter assembly 111, may include one or more magnetic detection sensors to determine the EM generated fields and/or the EM distortion fields. For example, in the reciprocal system, the information collected by the sensors of the magnetic field transmitter assembly 111 may include a received field signal indicating the EM distortion field transmitted by the distortion objects 130a and/or 130b and/or an EM generator field defined by a set of electromagnetic signals transmitted by the one or more magnetic field generator assemblies 106, 108, and 110 within the calibration device 126 and/or the medical device 104.

According to various embodiments of the disclosed subject matter, the functionality of any number of the components depicted in FIG. 1 (e.g., the field controller 114, the signal generator 116, the EM compensation device 118, the location unit 122, the EM compensation unit 124, the calibration device 126, the medical device 104, and/or the tracker device 132) may be implemented using one or more computing devices, either as a single unit or a combination of multiple, separate devices. For instance, in some examples, the functionalities of the EM compensation device 118 and the field controller 114 may be implemented using a single computing device. In other examples, the functionalities of the location unit 122 and the EM compensation unit 124 may be performed by separate devices.

FIG. 2 is a schematic block diagram depicting an illustrative EM compensation device 118, in accordance with embodiments of the disclosure. The EM compensation device 118, may include and/or be any type of computing device suitable for implementing aspects of embodiments of the disclosed subject matter. Examples of computing devices include specialized computing devices or general-purpose computing devices such “workstations,” “servers,” “laptops,” “desktops,” “tablet computers,” “hand-held devices,” “general-purpose graphics processing units (GPGPUs),” and the like, all of which are contemplated within the scope of this disclosure.

The EM compensation device 118 includes a bus 210 that, directly and/or indirectly, couples the following devices: a processor 220, a memory 230, an input/output (I/O) port 240, an I/O component 250, and a power supply 260. Any number of additional components, different components, and/or combinations of components may also be included in the EM compensation device 118. The I/O component 250 may include a presentation component configured to present information to a user such as, for example, a display device, a speaker, a printing device, and/or the like, and/or an input component such as, for example, a microphone, a joystick, a satellite dish, a scanner, a printer, a wireless device, a keyboard, a pen, a voice input device, a touch input device, a touch-screen device, an interactive display device, a mouse, and/or the like.

The bus 210 represents what may be one or more busses (such as, for example, an address bus, data bus, or combination thereof). Similarly, in embodiments, the EM compensation device 118 may include one or more processors 220, a number of memory components 230, a number of I/O ports 240, a number of I/O components 250, and/or a number of power supplies 260. Additionally any number of these components, or combinations thereof, may be distributed and/or duplicated across a number of computing devices. The one or more processors 220 may include the location unit 122 and/or the EM compensation unit 124.

The memory 230 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In some examples, the memory 230 stores computer-executable instructions 290 for causing the processor 220 to implement aspects of embodiments of system components discussed herein and/or to perform aspects of embodiments of methods and procedures discussed herein.

The computer-executable instructions 290 may include, for example, computer code, machine-useable instructions, and the like such as, for example, program components capable of being executed by one or more processors 220 associated with the EM compensation device 118. Program components may be programmed using any number of different programming environments, including various languages, development kits, frameworks, and/or the like. Some or all of the functionality contemplated herein may also, or alternatively, be implemented in hardware and/or firmware.

The illustrative EM compensation device 118 shown in FIG. 2 is not intended to suggest any limitation as to the scope of use or functionality of embodiments of the present disclosure. Neither should the illustrative EM compensation device 118 be interpreted as having any dependency or requirement related to any single component or combination of components illustrated therein. Additionally, various components depicted in FIG. 2 may be, in embodiments, integrated with various ones of the other components depicted therein (and/or components not illustrated), all of which are considered to be within the ambit of the present disclosure.

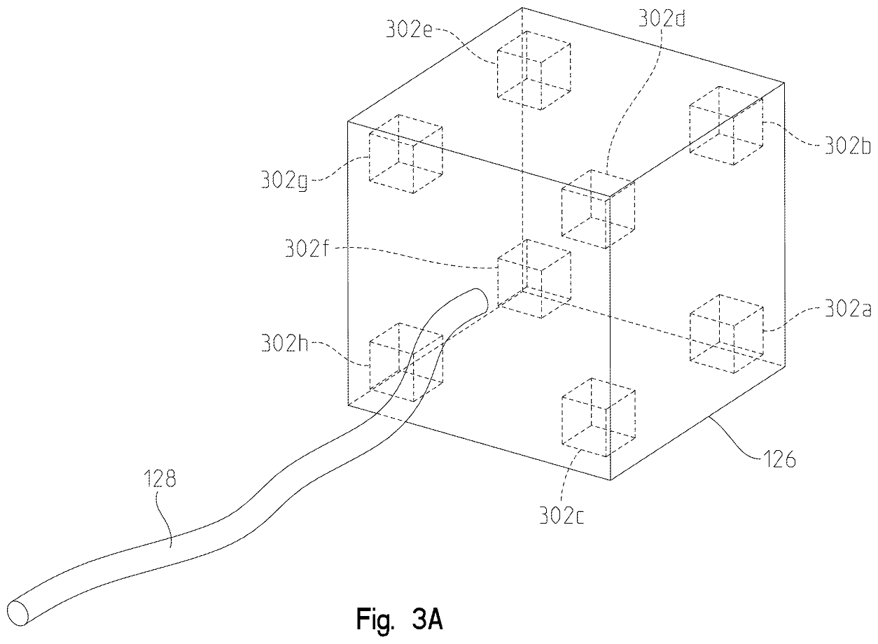

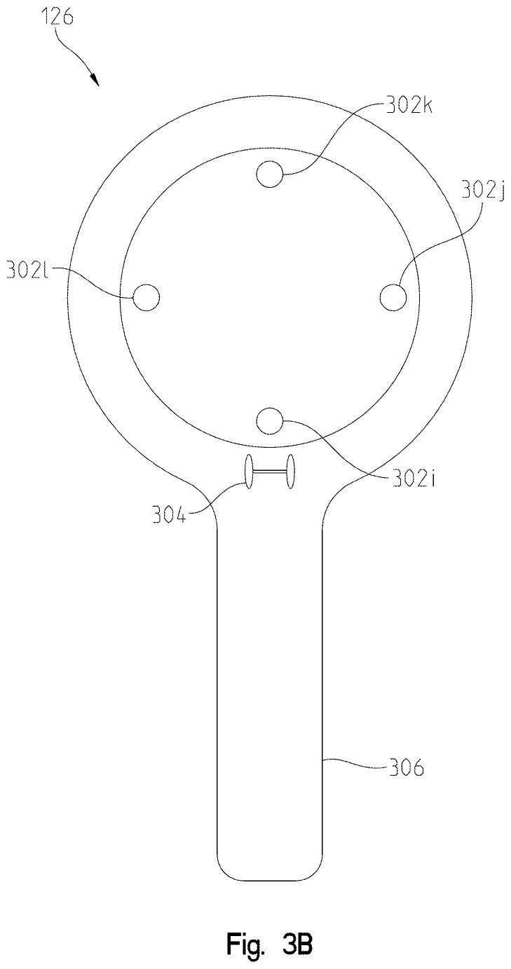

FIGS. 3A and 3B show exemplary calibration devices 126 that may be used to compensate for the EM distortion fields from the distortion objects 130. For example, in the embodiment shown in FIG. 3A, the calibration device 126 is communicatively coupled to the EM compensation device 118 by a wired connection 128. The calibration device 126 includes eight magnetic field detection sensors 302 a-h. The relative distances between each of the magnetic field detection sensors 302 a-h may be known by the calibration device 126 and/or the EM compensation device 118. In other words, the EM compensation device 118 may receive and/or store information indicating the geometric spacing of the field detection sensors 302 a-h relative to each other (e.g., the relative distances between each of the field detection sensors 302 a-h). For example, the sensors 302a and 302b may be separated by a certain distance such as 10 millimeters (mm). Sensors 302 a and 302 c may also be separated by 10 mm. The EM compensation device 118 may receive information indicating these separations and as will be explained below, may use these separation distances to compensate for the EM distortion fields.

In the embodiment shown in FIG. 3B, the calibration device 126 is in wireless communication with the EM compensation device 118. The calibration device 126 includes four magnetic field detection sensors 302i−1. Further, the calibration device 126 includes a handle 306 and a rotor wheel 304 that rotates the sensors 302 i−1 into different orientations. The calibration device 126 may provide the orientation of the sensors 302 i−1 and/or the sensor readings (e.g., detected EM fields) to the EM compensation device 118 via the wireless communication link 128. Additionally, and/or alternatively, the relative distances between each of the magnetic field detection sensors 302 a-h may be known by the calibration device 126 and/or the EM compensation device 118. While FIGS. 3A and 3B show two examples of the calibration device 126, additional examples of the calibration device 126, including calibration devices 126 with only a single magnetic field detection sensor and/or calibration devices 126 with different arrangements of the sensors, may be used by the EM compensation device 118 to compensate for the EM distortion fields.

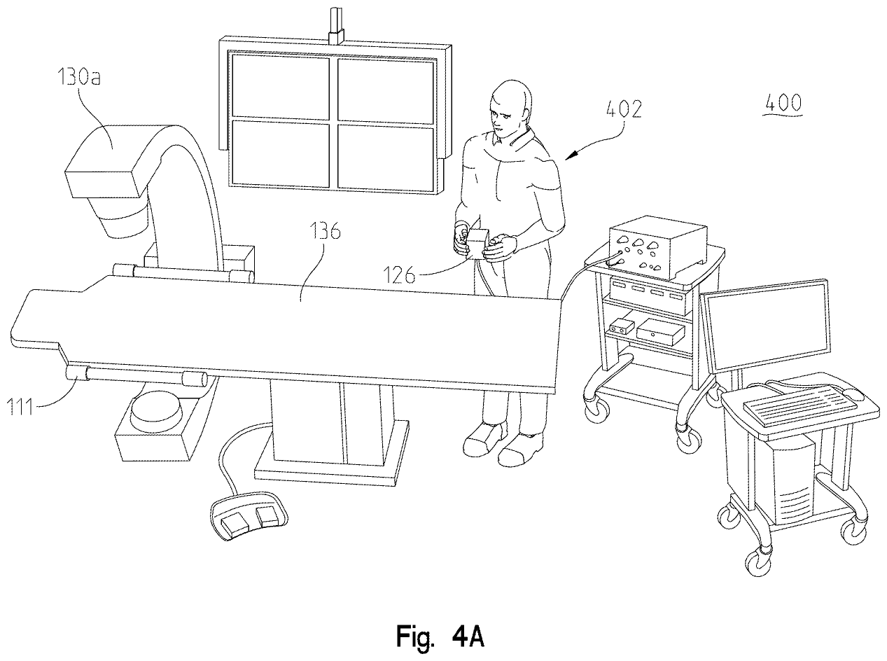

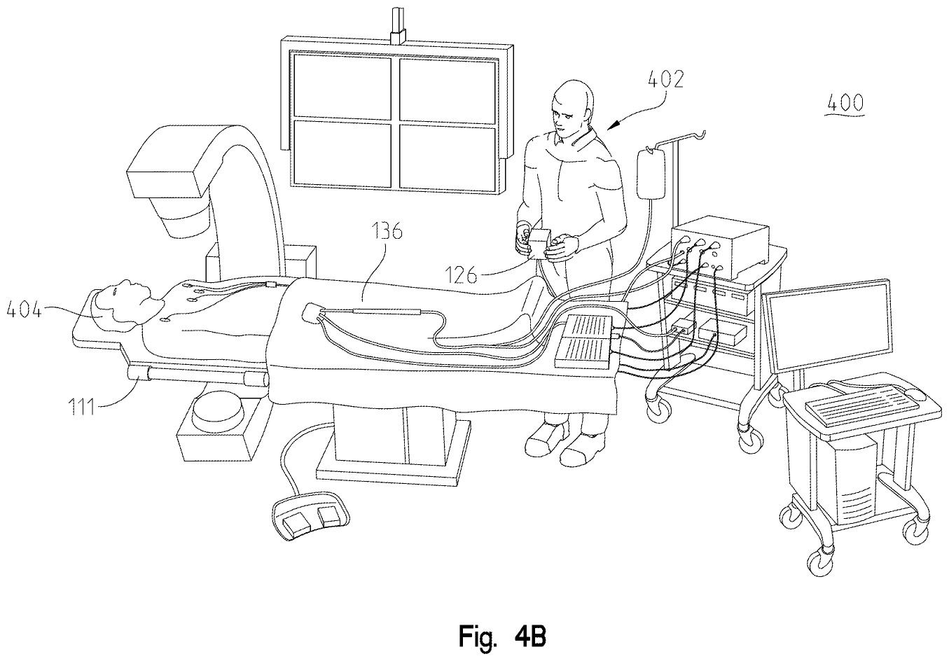

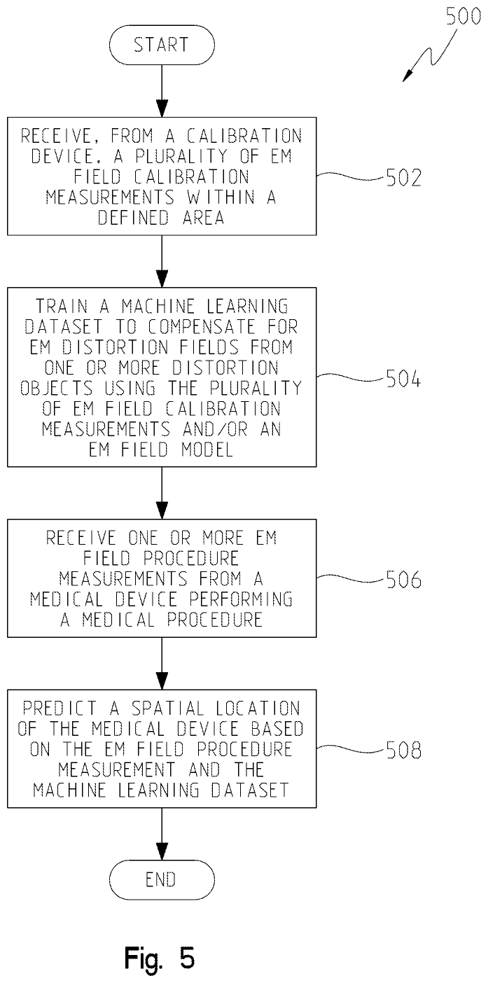

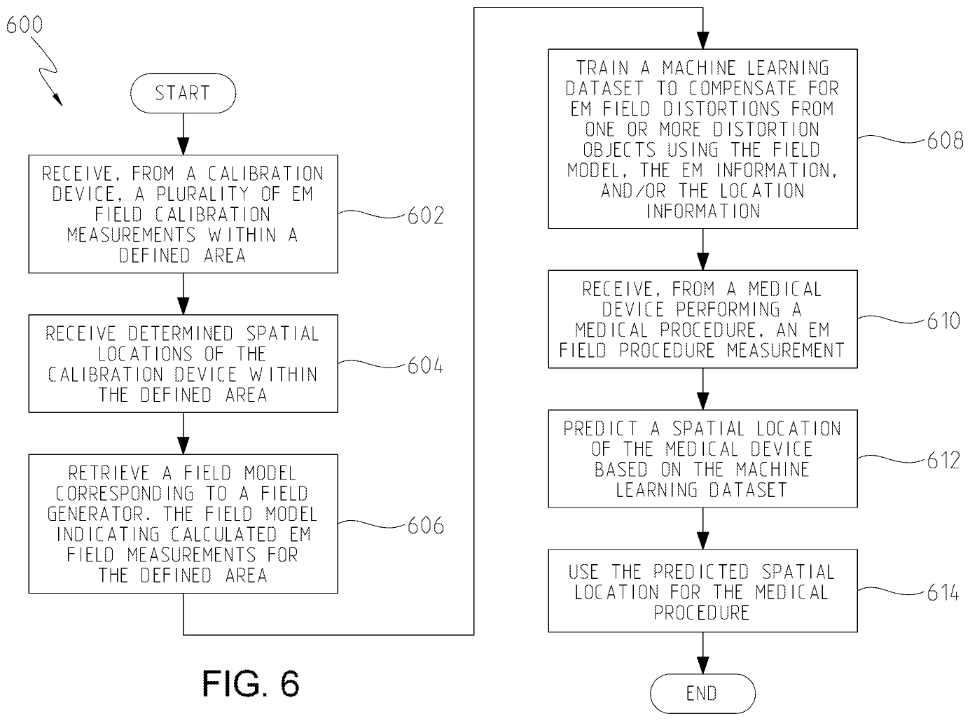

FIGS. 4A and 4B show an exemplary clinical setting 400 (e.g., a room and/or a defined area), including an electrophysiology mapping and navigation system incorporating the EM field compensation system 400, where a patient 404 (shown in FIG. 4B) may undergo a medical procedure such as an electrophysiology procedure. The defined area 400 may include one or more devices, objects, and/or other items from the EM field compensation system 100. For example, the defined area 400 may include one or more distortion objects 130 (e.g., the C-arm 130a) and/or one or more computing devices such as the field controller 114, the EM compensation device 118, and/or the calibration device 126. In some examples, one or more devices from the EM field compensation system 100 may be outside of the defined area 400. For example, the EM compensation device 118 may be located within another room and/or another building or dwelling. In other words, the EM compensation device 118 may remotely perform functions to compensate for the EM distortion fields within the defined area 400. FIGS. 4A and 4B will be used to describe the methods 500 and/or 600 shown in FIGS. 5 and 6.

FIG. 5 shows a block representation of steps in a method 500 for compensating for the EM distortion fields caused by distortion objects. The method 500 will be described with reference to the EM field compensation system 100 and the defined area 400. However, any suitable structure or system may be employed.

In operation, at step 502, the EM compensation device 118 receives, from a calibration device 126, EM calibration information indicating a plurality of EM field calibration measurements within a defined area. For example, referring to FIG. 4A, the calibration device 126 may use the one or more one or more magnetic field detection sensors (e.g., sensors 302 a-g) to determine (e.g., detect and/or collect) EM field measurements (e.g., EM distortion field measurements from the distortion objects 130 and/or EM generated field measurements from the one or more magnetic field generator assemblies 106-110). The EM field measurements may be taken at various spatial locations within the defined area 400. Afterwards, the EM compensation device 118 may receive the EM information indicating the EM field measurements from the calibration device 126.

In other words, the user 402 may seek to compensate for the EM distortion fields caused by the distortion objects 130, such as the C-arm 130a. The user 402 may turn on one or more magnetic field generator assemblies 106-110 that produce the EM generated fields. Furthermore, the magnetic field generator assemblies 106-110 induce the distortion objects (e.g., the C-Arm 130a) to produce the EM distortion fields. The user 402 may physically move around the defined area 400. While moving around the defined area 400, the calibration device 126 collects the EM field measurements and provides these EM field measurements to the EM compensation device 118. As such, the EM field measurements indicate the static distorters (e.g., distortion objects 130) within the defined area 400.

In some examples, the calibration device 126 may include more than one magnetic field detection sensor. Each magnetic field detection sensor (e.g., sensors 302 a-g) may collect EM field measurements at the various spatial locations within the defined area 400. The calibration device 126 may provide these EM field measurements and the corresponding sensor that collected the EM field measurement to the EM compensation device 118. Additionally, and/or alternatively, referring to FIG. 3B, the calibration device 126 may determine the orientation of each of the sensors (302i-1) as it collects the EM field measurements. The calibration device 126 may provide the EM field measurements and the corresponding orientation of the sensors to the EM compensation device 118.

At step 504, the EM compensation device 118 trains a machine learning dataset to compensate for the EM distortion fields from the one or more distortion objects using the plurality of EM field calibration measurements and/or an EM field model. For example, the EM compensation device 118 (e.g., the EM compensation unit 124) may use one or more machine learning algorithms to train the machine learning dataset. For instance, the inputs to the machine learning algorithm may be the EM field calibration measurements from step 502 and/or an EM field model. The output of the machine learning algorithm may be an estimated or predicted spatial location of the calibration device 126.

The EM field model may be a model representing non-distorted EM field measurements at various spatial locations within the defined area 400. For example, a device, such as the field controller 114 and/or the EM compensation device 118, may generate, compute, and/or calculate the EM field model based on the magnetic field generator assemblies 106-110. For instance, each of the magnetic field generator assemblies 106-110 may include one or more coil windings (e.g., copper coils). Based on the geometry of the coil windings, the device may compute the EM field strengths within the defined area 400. In other words, each magnetic field generator assembly may generate an EM field with a known EM field strength within the defined area 400. Based on aggregating the known EM generated fields (e.g., the EM field strengths) from the magnetic field generator assemblies 106-110 within the system 100, the device may generate the EM field model indicating the strength of the EM fields at various locations within the defined area 400. The EM compensation device 118 may receive and/or store the EM field model in memory, such as memory 230.

In some examples, the EM field model for the defined area 400 may be represented by a volume of space and/or a 3-D coordinate system. For example, the device determines (e.g., calculates) EM field strengths for each sub-volume (e.g., portion or region) within the defined area 400. Each sub-volume within the defined area 400 (e.g., for each spatial location) may be represented by a corresponding x, y, and z coordinate within the 3-D coordinate system.

In some variations, the EM compensation device 118 may train the machine learning dataset to correct the EM field model such that the EM distortion fields caused by the distortion objects 130 are accounted for (e.g., by using one or more loss functions). For example, initially, without any training, the EM compensation device 118 may determine or predict the spatial location of the calibration device 126 by associating an EM field calibration measurement with a spatial location within the EM field model with a substantially similar EM field measurement. The EM compensation device 118 may determine one or more errors (e.g., error measurements) associated with the predicted spatial location of the calibration device 126. Then, using the error(s), the calibration device 126 may update the machine learning dataset to better predict the spatial location of the calibration device 126 by using one or more loss functions. The EM compensation device 118 may continue training the machine learning dataset using the EM field calibrations, the determined errors and/or loss functions, and the EM field model. In some variations, after training the machine learning dataset, the EM compensation device 118 may store the machine learning dataset in memory, such as memory 230. Exemplary machine learning algorithms (e.g., neural networks) are described below in FIGS. 6, 7, and 8. However, any type of machine learning algorithm may be used by the EM compensation device 118 to train the machine learning dataset to compensate for the EM distortion fields.

Subsequent to training the machine learning dataset, at step 506, the EM compensation device 118 receives EM procedure information indicating one or more EM field procedure measurements from a medical device (e.g., medical device 104 and/or receiver 102) performing a medical procedure. The EM field procedure measurements include the EM distortion fields from the distortion objects 130 and the EM generated fields from the magnetic field generator assemblies 106-110. For example, referring to FIG. 4B, a patient 404 may be undergoing a medical procedure. The medical device 104 may be inserted within the patient 404 and the receiver 102 may determine (e.g., collect) EM field measurements as described above. The receiver 102 and/or medical device 104 may provide the EM field measurements (e.g., EM field procedure measurements) to the EM compensation device 118.

At step 506, the EM compensation device 118 (e.g., the location unit 122) predicts a spatial location of the medical device 104 based on the EM field procedure measurement (from step 506) and the machine learning dataset (from step 504). For example, the EM compensation device 118 may use the EM field procedure measurement (e.g., strength of EM field) and the machine learning dataset to more accurately determine the spatial location of the medical device 104. For instance, the medical device 104 may be an imaging device inserted within the patient 404. The EM compensation device 118 may receive the images and the strength of the EM fields (e.g., the EM field procedure measurement). Using the machine learning dataset and the EM field procedure measurement, the EM compensation device 118 may predict a spatial location of the medical device 104.

In some instances, the calibration device 126 may determine EM field measurements when the C-Arm 130a is at different orientations (e.g., set positions). For example, a user may orient the C-Arm 130a into multiple different orientations. The calibration device 126 may determine the EM field calibration measurements for each orientation of the C-Arm. Then, method 500 may train different machine learning datasets for each orientation of the C-Arm. Depending on the orientation of the C-Arm during the medical procedure, the EM compensation device 118 may use the corresponding machine learning dataset to predict the spatial location of the medical device 104.

FIG. 6 shows a block representation of steps in a method 600 for compensating for the EM distortion fields caused by distortion objects. Method 600 shows a more detailed version of method 500 and will be described with reference to the EM field compensation system 100 and the defined area 400. However, any suitable structure or system may be employed.

In operation, similar to step 502, at step 602, the EM field compensation device 118 receives, from the calibration device 126, EM field calibration measurements for (e.g., within) a defined area. Referring to FIGS. 4a and 4b, the defined area may include the entire environment 400. However, in some examples, the defined area may include less than the entire environment 400. For example, the defined area may include spatial locations where the patient 404 will be situated during a medical procedure such as the area surrounding the bed or table 136.

At step 604, the EM field compensation device 118 receives determined spatial locations of the calibration device 126 within the defined area from the tracker device 132. Each EM field calibration measurement from step 602 may have a corresponding estimated spatial location from the tracker device 132. For example, each time the calibration device 126 determines an EM field calibration measurement, the tracker device 132 may determine a corresponding spatial location and associate the spatial location with the EM field calibration measurement. The tracker device 132 may transmit location information indicating the determined spatial locations of the calibration device 126 and the corresponding EM field calibration measurement associated with the determined spatial locations to the EM field compensation device 118. In some examples, each time the calibration device 126 determines an EM field calibration measurement, the calibration device 126 and/or the EM field compensation device 118 may provide information (e.g., a signal) to the tracker device 132 to determine a corresponding spatial location.

At step 606, the EM field compensation device 118 retrieves a field model corresponding to a field generator (e.g., the magnetic field generator assemblies 106, 108, and 110 within the magnetic field transmitter assembly 111). The field model indicates calculated EM field measurements for the defined area. For example, after generating the field model (described above), the EM field compensation device 118 may retrieve the field model from memory, such as memory 230.

At step 608, the EM field compensation device 118 trains a machine learning dataset to compensate for EM distortion fields from the one or more distortion objects 130 using the field model, the EM information, and/or the location information. For example, the EM field compensation device 118 may use an artificial neural network (e.g., machine learning dataset) to compensate for the EM distortion fields. Generally speaking, artificial neural networks are computational models based on structures and functions of biological neural networks. Artificial neural networks may be implemented under a variety of approaches, including a multilayer feedforward network approach (as described below) or a recurrent neural network approach, among others. One artificial neural network approach involves identifying various inputs and target outputs for training an artificial neural network. For example, a set of “training data”—with known inputs and known outputs such as—is used to train the artificial neural network. The training data may be data samples for multiple types or categories of data and corresponding known target results for each data sample. The known inputs and outputs (e.g., the EM field calibration measurements, the corresponding determined spatial locations, and/or the field model) are fed into the artificial neural network, which processes that data to train itself to resolve/compute results for additional sets of data, this time with new inputs and unknown results (e.g., EM field procedure measurements and the predicted spatial location of the medical device 104). As a result, the artificial neural network may predict target outputs from a set of inputs. In this manner, a trained artificial neural network may use inputs that, individually, may not be direct parameters for particular tests or testing schemes and that may include different classes of parameters/data, to produce desired target outputs for those tests or testing schemes.

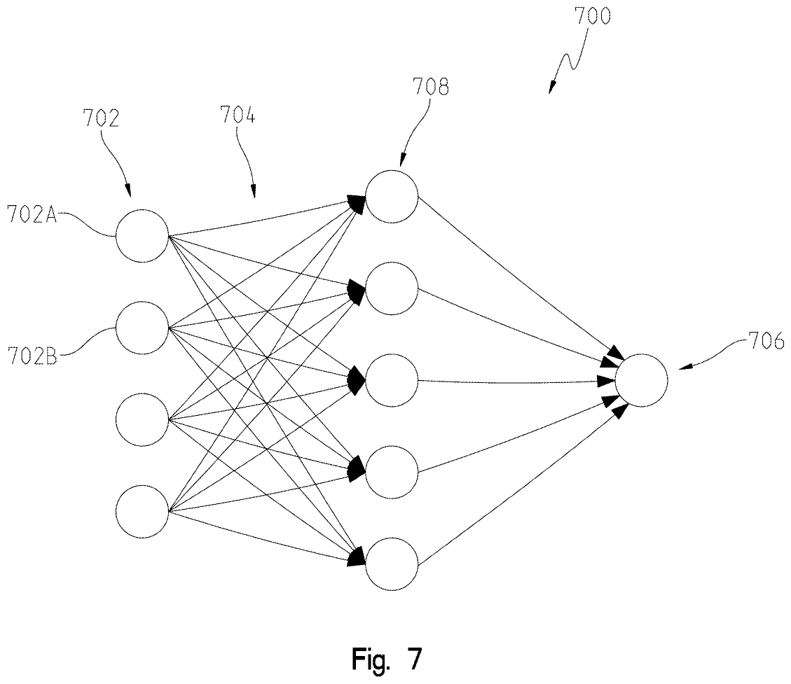

A visualization of an artificial neural network 700 (e.g., machine learning dataset 700) is shown in FIG. 7. The artificial neural network 700 includes a number of nodes (sometimes referred to as neurons) 702 and connections 704, each of which run between a source node (e.g., 702A, 702B) and a target node (e.g., 706) in a single direction. Each node 702 represents a mathematical function (e.g., summation, division) applied to the one or more input of that node 702. Thus, each node represents types or classes of data.

An adaptive weight is associated with each connection 704 between the nodes 702. The adaptive weight, in some embodiments, is a coefficient applied to a value of the source node (e.g., 702A) to produce an input to the target node 706. The value of the target node is, therefore, a function of the source node inputs 702A, 702B, etc., multiplied by their respective weighting factors. For example, a target node 706 may be some function involving a first node 702A multiplied by a first weighting factor, a second node 702B multiplied by a second weighting factor, and so on. FIG. 7 also shows a number of hidden nodes 708, which will be explained in more detail below.

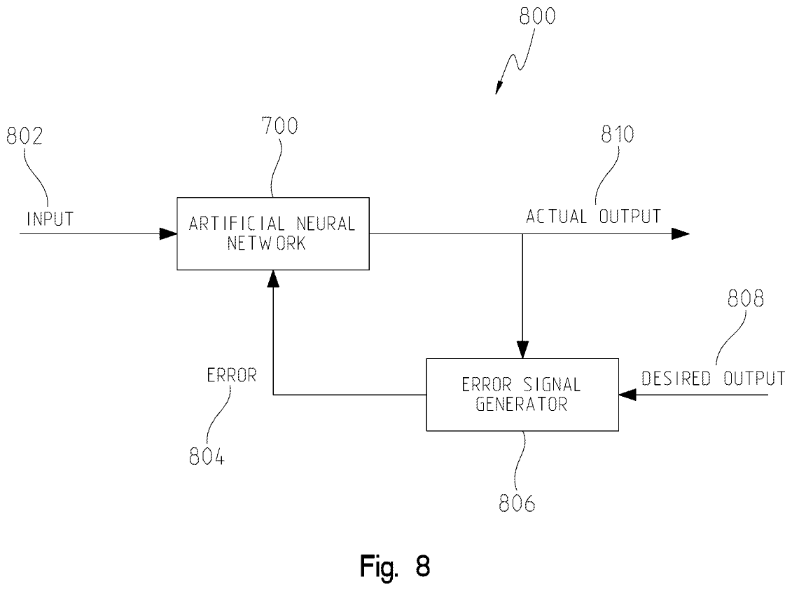

FIG. 8 shows a diagram 800 of one approach to compute weighting factors associated with each connection 704 of the artificial neural network 700. The weighting factors are initially set to random values. Input nodes 702A, 702B, etc.—which represent types or classes of input data as discussed above—and a target node 706 are chosen to create node pairs. Next, activations (e.g., input 802) are propagated from the input nodes 702A, 702B to hidden nodes 708 for each input node 702, and then activations are propagated from the hidden nodes 708 to target nodes 706 for each hidden node 708. An error value 804 is then computed for target nodes 706 by an error signal generator 806 by comparing the desired output 808 to the actual output 810.

Next, error 804 is computed for hidden nodes 708. Based on the computed errors, weighting factors from the connections 704 are adjusted between the hidden nodes 708 and target nodes 706. Weighting factors are then adjusted between the input nodes 702 and the hidden nodes 708. To continue to update the weighting factors (and therefore train the artificial neural network 700), the process restarts where activations are propagated from the input nodes 702 to hidden layer nodes 708 for each input node 702. The artificial neural network 700 is “trained” once little to no error is computed, with weighting factors relatively settled. Essentially, the trained artificial neural network 700 learns what nodes (and therefore, inputs) should be given more weight when computing the target output.

In other words, the EM field compensation device 118 may provide the field model, the EM information, and/or the location information as the inputs 802 into one or more artificial neural networks 700 (e.g., the machine learning dataset). Using the artificial neural networks 700, the EM field compensation device 118 may determine the actual outputs 810, which may indicate predicted spatial locations of the calibration device 126. The EM field compensation device 118 may use the error signal generator 806 to determine one or more errors between the actual output 810 and a desired output 808. For example, the desired output 808 may be the determined spatial locations from the tracker device 132. In other words, the EM field compensation device 118 may determine the error based on differences between the determined spatial locations from the tracker device 132 and the predicted spatial locations. Based on the computed errors, the EM field compensation device 118 trains the machine learning dataset by adjusting the weighting factors from the connections 704 between the hidden nodes 708 and target nodes 706. The EM field compensation device 118 may continuously train the machine learning dataset until little to no error is computed and the weighting factors are relatively settled. In some examples, the EM field compensation device 118 uses one or more loss functions to determine the error. For example, the EM field compensation device 118 may determine the error using a loss function associated with the error between the actual output 810 (e.g., the predicted spatial location) and the desired output (e.g., determined spatial location).

Steps 610-614 are similar to steps 506 and 508 described above. For example, at step 610, the EM field compensation device 118 receives, from the medical device 104 performing a medical procedure, an EM field procedure measurement. At step 612, the EM field compensation device 118 predicts a spatial location of the medical device 104 based on the machine learning dataset. For example, after training the neural network 700 (e.g., the machine learning dataset), the EM field compensation device 118 provides the EM field procedure measurement as an input to the neural network 700. The predicted spatial location is the actual output 810 of the neural network 700. At step 614, the EM field compensation device 118 uses the predicted spatial location for the medical procedure.

In some examples, the EM field compensation device 118 may use additional and/or alternative inputs 802, desired outputs 808, and/or error calculations/errors 804 to train the machine learning dataset. For instance, the EM field compensation device 118 may use EM field measurements from multiple magnetic field detection sensors, the relative distances between each of the magnetic field detection sensors, and/or the orientation of the sensors to train the machine learning dataset. Referring to FIG. 3A, the calibration device 126 includes the magnetic field detection sensors 302 a-h that determine EM calibration measurements. The EM field compensation device 118 may receive EM calibration measurements from each of these sensors 302 a-h and use them as inputs 802 to train the machine learning dataset.

In some instances, the EM field compensation device 118 may use a single artificial neural network (e.g., the artificial neural network 700) to perform the steps from method 500 and/or 600 (e.g., to train the machine learning dataset and/or predict the spatial location of the medical device 104). In other instances, the EM field compensation device 118 may use multiple artificial neural networks to perform the steps from method 500 and/or 600. For example, for each magnetic field detection sensor (e.g., sensors 302 a-h), the EM field compensation device 118 may use a different artificial network to train a corresponding machine learning dataset. The EM field compensation device 118 may then use each of the corresponding machine learning datasets to predict the spatial position of the medical device 104.

Additionally, and/or alternatively, the EM field compensation device 118 may use the relative distances between each of the magnetic field detection sensors (e.g., the geometric spacing between the sensors) to determine the errors 804. For example, the actual output 810 may indicate predicted spatial positions of and/or between each of the magnetic field detection sensors 302 a-h. The EM field compensation device 118 may compare the predicted spatial positions of and/or between each of the magnetic field detection sensors 302 a-h with the desired output 808 (e.g., determined spatial positions of the sensors 302 a-h from the tracker device 132 and/or actual known relative distances between each of the field detection sensors 302 a-h). For example, the magnetic field detection sensors 302 a may be 10 millimeters (mm) apart from the magnetic field detection sensors 302 c. The EM field compensation device 118 may determine the error 804 based on the predicted spatial positions for the sensors 302a and 302 c and the actual geometric spacing between the two sensors 302a and 302c (e.g., 10 mm). The EM field compensation device 118 may use this error 804 to train the machine learning dataset. In some examples, the EM field compensation device 118 uses two or more loss functions to determine the error. For example, as explained above, the EM field compensation device 118 may determine a first error using a first loss function associated with the error between a first actual output 810 (e.g., the predicted spatial location of the calibration device 126) and a first desired output 808 (e.g., the determined spatial location of the calibration device 126). Additionally, and/or alternatively, the EM field compensation device 118 may determine the error using a second loss function associated with a second error between a second actual output 810 (e.g., the predicted spatial positions for magnetic field detection sensors such as sensors 302 a-h) and a second desired output 808 (e.g., determined spatial positions of the sensors 302 a-h from the tracker device 132 and/or actual known relative distances between each of the field detection sensors 302 a-h).

In some examples, the EM field compensation device 118 may determine the error 804 between the predicted spatial positions and the actual geometric spacing of the magnetic field detection sensors using Procrustes transformations. Procrustes transformations may allow the correction of spatial locations determined by the field model prior to using it as training data (e.g., error calculations) for the machine learning model (e.g., the artificial neural network 700). For example, while the rigid locations of the magnetic field detection sensors (e.g., sensors 302 a-h) force a specific geometry on their layout, the spatial locations of the sensors 302 a-h predicted by the EM field compensation device 118 under distortion might not obey that geometry. Therefore, by using Procrustes transformation (using only 3-D translation and/or rotation), the EM field compensation device 118 may align the known rigid geometry with the predicted spatial locations for maximal overlap, thus reducing the effect of distortion prior to the training of the machine learning model.

In some instances, the EM field compensation device 118 may provide different weights to the predicted versus determined spatial locations of the calibration device 126 and the determined versus actual geometric spacing between the magnetic field detection sensors to determine the errors 804. For example, the determined spatial location from the tracker device 132 might not be the same as the actual location of the calibration device 126. When training the machine learning dataset, the EM field compensation device 118 may more heavily weigh the geometric spacing between the determined/actual the magnetic field detection sensors compared to the predicted/determined spatial locations of the calibration device 126. In other words, when updating the machine learning dataset, the EM field compensation device 118 may prioritize the errors from the geometric spacing between the determined/actual the magnetic field detection sensors over the errors from the predicted/determined spatial locations of the calibration device 126. In other instances, the EM field compensation system 100 might not include a tracker device 132 and the EM field compensation device 118 may use the determined versus actual geometric spacing between the magnetic field detection sensors to determine the errors 804 and update/train the machine learning dataset.

In some variations, the EM field compensation device 118 may predict the orientation of the medical device 104 using the machine learning dataset. For example, referring to FIG. 3B, the calibration device 126 may provide the orientation indicated by the rotor wheel 304 of the sensors 302 i−1 to the EM field compensation device 118. The EM field compensation device 118 may use the orientation of the sensors to train the machine learning dataset. For instance, the EM field compensation device 118 may use the machine learning dataset to determine an orientation of the sensors of the calibration device 126. The EM field compensation device 118 may compare the determined orientation of the sensors with the actual position provided by the calibration device 126. Then, similar to step 506 and/or 508, the EM field compensation device 118 may predict an orientation of the medical device based on the one or more EM field procedure measurements from the medical device and the machine learning dataset.

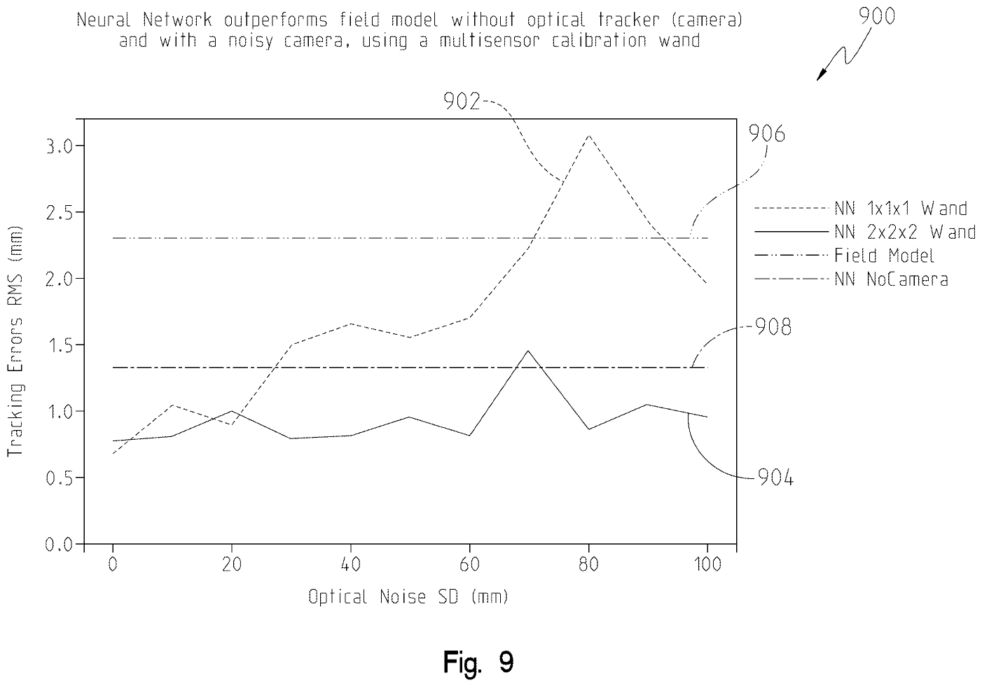

FIG. 9 shows a graphical representation 900 of using the methods 500 and/or 600 to compensate for the EM distortion fields caused by the one or more distortion objects 130. The y-axis shows the root-mean-square tracking error across the entire sub-volume (e.g., defined area 400) in millimeters. The x-axis shows the amount of noise (measured by its standard deviation in millimeters) added to the spatial position to simulate noise in the optical tracker. Note that this does not affect the Field Model 906 and the neural network (NN) NoCamera 908 methods which do not use an optical tracker. The Field Model 906 method uses the magnetic field detection sensor values to estimate the spatial position without a machine learning model. The NN 1×1×1 Wand 902 method uses a calibration device 126 with a single magnetic field detection sensor and a tracker device 132 (e.g., an optical tracker) to create a calibration dataset for the machine learning model. As optical noise increases, model performance may deteriorate. The NN 2×2×2 Wand 904 method uses a calibration device 126 with a 2×2×2 grid of 8 magnetic field detection sensors (e.g., similar to the device 126 shown in FIG. 3A) and a tracker device 132 (e.g., an optical tracker) to create a calibration dataset for the machine learning model. As optical noise increases, model performance deteriorates, but not as much as the 1×1×1 sensor wand, because the model uses the relative geometry of the sensors to improve performance. The NN NoCamera 908 method uses a calibration device 126 with a 2×2×2 grid of 8 magnetic field detection sensors without a tracker device 132 (e.g., an optical tracker) to create a calibration dataset for the machine learning model. While this method has a slightly worse performance than NN 2×2×2 Wand 904, it does not require the additional technology of an optical tracker.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A method for compensating for electromagnetic (EM) distortion fields caused by one or more distortion objects, comprising:
receiving, by an EM compensation device and from a calibration device, a plurality of EM field calibration measurements within a defined area;
training, by the EM compensation device, a machine learning dataset to compensate for the EM distortion fields caused by the one or more distortion objects using the plurality of EM field calibration measurements and an EM field model;
receiving, by the EM compensation device, one or more EM field procedure measurements from a medical device performing a medical procedure; and
predicting a spatial location of the medical device based on the one or more EM field procedure measurements and the machine learning dataset.

2. The method of claim 1, further comprising:
receiving, by the EM compensation device and from a tracker device, a plurality of determined spatial locations of the calibration device, wherein each of the plurality of determined spatial locations corresponds to a corresponding EM field calibration measurement from the plurality of EM field calibration measurements, and
wherein the training the machine learning dataset is further based on the plurality of determined spatial locations of the calibration device.

3. The method of claim 2, wherein the training the machine learning dataset comprises:
using the plurality of EM field calibration measurements, the EM field model, and the machine learning dataset to determine a predicted spatial location of the calibration device; and
updating the machine learning dataset based on an error between the predicted spatial location and a determined spatial location from the plurality of determined spatial locations.

4. The method of claim 2, wherein the tracker device includes at least one of: an optical tracker device, an inertial measurement unit (IMU), a depth camera, and a laser tracker.

5. The method of claim 1, further comprising:
determining, based on one or more magnetic field generators, the EM field model, wherein the EM field model indicates a plurality of non-distorted EM field measurements within the defined area that are caused solely by the one or more magnetic field generators.

6. The method of claim 1, wherein the calibration device comprises a plurality of magnetic field detection sensors, and wherein each of the plurality of EM field calibration measurements indicates a corresponding magnetic field detection sensor, from the plurality of magnetic field detection sensors, that determined the EM field calibration measurement.

7. The method of claim 6, further comprising:
determining geometric spacing for the calibration device and corresponding to the plurality of magnetic field detection sensors, and
wherein the training the machine learning dataset is further based on the geometric spacing corresponding to the plurality of magnetic field detection sensors.

8. The method of claim 1, wherein the training the machine learning dataset comprises:
determining a first error corresponding to a predicted spatial location of the calibration device and a determined spatial location from a tracker device, wherein the predicted spatial location is determined using the machine learning dataset;
determining a second error corresponding to a determined geometric spacing between a plurality of magnetic field detection sensors corresponding to the calibration device and an actual geometric spacing between the plurality of magnetic field detection sensors, wherein the determined geometric spacing is determined using the machine learning dataset; and
updating the machine learning dataset based on the first error and the second error.

9. The method of claim 8, wherein the updating the machine learning dataset comprises prioritizing the second error corresponding to the determined geometric spacing and the actual geometric spacing over the first error corresponding to the predicted spatial location and the determined spatial location.

10. The method of claim 1, further comprising:
receiving, from the calibration device, a plurality of determined orientation measurements of the calibration device, wherein each of the plurality of determined orientation measurements corresponds to a corresponding EM field calibration measurement from the plurality of EM field calibration measurements;
training the machine learning dataset based on the plurality of determined orientation measurements; and
predicting an orientation of the medical device based on the machine learning dataset and the one or more EM field procedure measurements.

11. A system for compensating for electromagnetic (EM) distortion fields caused by one or more distortion objects, comprising:
a calibration device configured to provide a plurality of EM field calibration measurements; and
an EM compensation device comprising:
one or more processors; and
memory storing instructions that, when executed by the one or more processors, cause the one or more processors to:
receive, from the calibration device, the plurality of EM field calibration measurements within a defined area;
receive, from a tracker device, a plurality of determined spatial locations of the calibration device, wherein each of the plurality of determined spatial locations corresponds to a corresponding EM field calibration measurement from the plurality of EM field calibration measurements;
receive one or more EM field procedure measurements from a medical device performing a medical procedure; and
predict a spatial location of the medical device based on the one or more EM field procedure measurements, the plurality of determined spatial locations of the calibration device, and the plurality of EM field calibration measurements.

12. The system of claim 11, wherein the calibration device comprises one or more magnetic field generators.

13. The system of claim 11, wherein the memory stores instructions that, when executed by the one or more processors, further cause the one or more processors to:
train a machine learning dataset to compensate for the EM distortion fields caused by the one or more distortion objects using the plurality of EM field calibration measurements and an EM field model, and
wherein the predicting the spatial location of the medical device is further based on the machine learning dataset.

14. The system of claim 13, wherein the training the machine learning dataset comprises:
using the plurality of EM field calibration measurements, the EM field model, and the machine learning dataset to determine a predicted spatial location of the calibration device; and
updating the machine learning dataset based on an error between the predicted spatial location and a determined spatial location from the plurality of determined spatial locations.

15. The system of claim 13, wherein the calibration device comprises a plurality of magnetic field detection sensors, and wherein each of the plurality of EM field calibration measurements indicates a corresponding magnetic field detection sensor, from the plurality of magnetic field detection sensors, that determined the EM field calibration measurement.

16. The system of claim 15, wherein the memory stores instructions that, when executed by the one or more processors, further cause the one or more processors to:
determine geometric spacing for the calibration device and corresponding to the plurality of magnetic field detection sensors, and
wherein the training the machine learning dataset is further based on the geometric spacing corresponding to the plurality of magnetic field detection sensors.

17. The system of claim 13, wherein the training the machine learning dataset comprises:
determining a first error corresponding to a predicted spatial location of the calibration device and a determined spatial location from the tracker device, wherein the predicted spatial location is determined using the machine learning dataset;
determining a second error corresponding to a determined geometric spacing between a plurality of magnetic field detection sensors corresponding to the calibration device and an actual geometric spacing between the plurality of magnetic field detection sensors, wherein the determined geometric spacing is determined using the machine learning dataset; and
updating the machine learning dataset based on the first error and the second error.

18. The system of claim 13, wherein the memory stores instructions that, when executed by the one or more processors, further cause the one or more processors to:
receive, from the calibration device, a plurality of determined orientation measurements of the calibration device, wherein each of the plurality of determined orientation measurements corresponds to a corresponding EM field calibration measurement from the plurality of EM field calibration measurements;
train the machine learning dataset based on the plurality of determined orientation measurements; and
predict an orientation of the medical device based on the machine learning dataset and the one or more EM field procedure measurements.

19. A non-transitory computer readable medium storing instructions for execution by one or more processors incorporated into a system, wherein execution of the instructions by the one or more processors cause the one or more processors to:
receive, from a calibration device, a plurality of EM field calibration measurements within a defined area;
receive, from a tracker device, a plurality of determined spatial locations of the calibration device, wherein each of the plurality of determined spatial locations corresponds to a corresponding EM field calibration measurement from the plurality of EM field calibration measurements;
receive one or more EM field procedure measurements from a medical device performing a medical procedure; and
predict a spatial location of the medical device based on the one or more EM field procedure measurements, the plurality of determined spatial locations of the calibration device, and the plurality of EM field calibration measurements.

20. The non-transitory computer readable medium of claim 19, wherein execution of the instructions by the one or more processors further cause the one or more processors to:
train a machine learning dataset to compensate for the EM distortion fields caused by one or more distortion objects using the plurality of EM field calibration measurements and an EM field model, and
wherein the predicting the spatial location of the medical device is further based on the machine learning dataset.
